(19) United States
(12) Patent Application Publication
(10) Pub. No.: US 2010/0125726 A1
(43) Pub. Date: May 20, 2010

(54) THIN CLIENT HOST WAKEUP METHOD AND THIN CLIENT HOST

(75) Inventors: Chih-Wei CHEN, TAIPEI CITY (TW); Hsiao-Fen LU, TAIPEI CITY (TW)

Correspondence Address: BRIAN M. MCINNIS, 12th Floor, Ruttonjee House, 11 Duddell Street, Hong Kong, HK

(73) Assignee: INVENTEC CORPORATION, TAIPEI CITY (TW)

(21) Appl. No.: 12/351,814

(22) Filed: Jan. 10, 2009

(30) Foreign Application Priority Data
Nov. 20, 2008 (TW) 97144930

(51) Int. Cl. G06F 1/24

(52) U.S. Cl. 713/100

(57) ABSTRACT

A thin client host wakeup method to switch a thin client host from a sleep mode back to an active mode, wherein the thin client host wakeup method comprises the steps of: receiving a wake on LAN packet to generate a wakeup interrupt; determining, a storing module of the thin client host having a sleep flag; generating a trigger signal to the power module to activate the power module; electrically connecting the power module to a power switch; and retrieving a former system status and switching the thin client host from the sleep mode back to the active mode according to the former system status.

### RELATED APPLICATIONS

This application claims priority to Taiwan Application Serial Number 97144930, filed Nov. 20, 2008, which is herein incorporated by reference.

### BACKGROUND

1. Field of Invention

The present invention relates to a thin client host wakeup method. More particularly, the present invention relates to a thin client host wakeup method and a thin client host.

2. Description of Related Art

A thin client (sometimes also called a lean or slim client) is a client computer or client software in client-server architecture networks that depends primarily on the central server for processing activities, and mainly focuses on conveying input and output between the user and the remote server. Many thin client devices run only web browsers or remote desktop software, meaning that all significant processing occurs on the server and each thin client device doesn't comprise complicated modules. However, the thin client host is much more simple than a complete computer. Thus the thin client host doesn't have a power management system like advanced configuration and power Interface (ACPI) and can't deal with the switching mechanism between the sleep mode and active mode.

Thus, what is needed is a thin client host and a thin client host wakeup method to perform a wakeup mechanism on a thin client host to switch the thin client host from the sleep mode to the active mode. The present invention addresses such a need.

### SUMMARY

A thin client host wakeup method is provided. A thin client host wakeup method switches a thin client host from a sleep mode back to an active mode, wherein the thin client host wakeup method comprises the steps of: receiving a wake on LAN packet to generate a wakeup interrupt; determining a storing module of the thin client host having a sleep flag; generating a trigger signal to the power module to activate the power module; electrically connecting the power module to a power switch; and retrieving a former system status and switching the thin client host from the sleep mode back to the active mode according to the former system status.

Another object of the present invention is to provide a thin client host having a sleep mode and an active mode, wherein the thin client host comprises: a storing module, a power module, a network module and a processing module. The storing module is to store a sleep flag during the sleep mode. The power module is to provide the power of the thin client during the active mode. The network module is to receive a wake on LAN (WOL) packet to generate a wakeup interrupt, and the processing module is to receive the wakeup interrupt to determine the storing module has the sleep flag and further generate a trigger signal to the power module to activate the power module and electrically connect the power module to a power switch, the processing module further retrieves a former system status and switches the thin client host from the sleep mode back to the active mode according to the former system status.

It is to be understood that both the foregoing general description and the following detailed description are by examples, and are intended to provide further explanation of the invention as claimed.

### BRIEF DESCRIPTION OF THE DRAWINGS

The invention can be more fully understood by reading the following detailed description of the embodiment, with reference made to the accompanying drawings as follows:

FIG. 1 is a block diagram of a thin client host of the first embodiment of the present invention; and

FIG. 2 is a flow chart of the thin client host wakeup method of the second embodiment of the present invention.

### DETAILED DESCRIPTION

Reference will now be made in detail to the present embodiments of the invention, examples of which are illustrated in the accompanying drawings. Wherever possible, the same reference numbers are used in the drawings and the description to refer to the same or like parts.

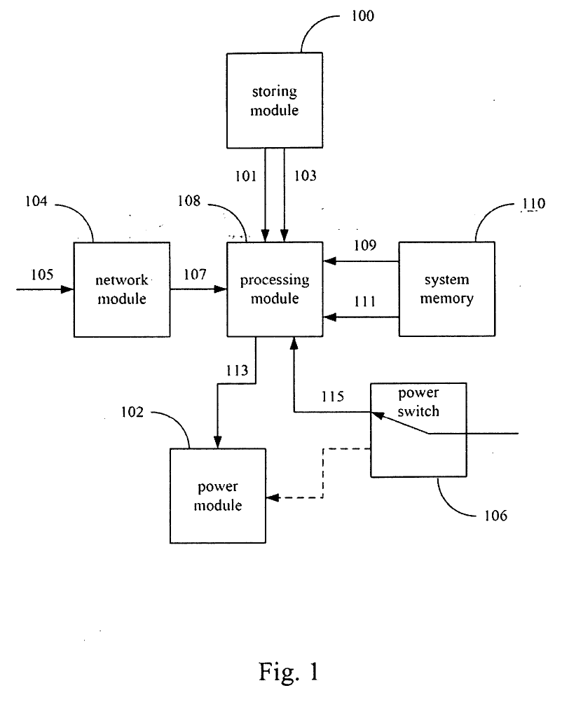

Please refer to FIG. 1, a block diagram of a thin client host 1 of the first embodiment of the present invention. The thin client host 1 has a sleep mode and an active mode, wherein the thin client host comprises: a storing module 100, a power module 102, a network module 104, a power switch 106, a processing module 108 and a system memory 110. The processing module 108 is substantially a central processing unit. When the thin client host 1 is in the sleep mode, the peripheral devices (not shown) of the thin client host 1 will be shut down. The processing module 108 lowers the operating frequency as well to lower the electric power consumption. The storing module 100 is to store a sleep flag 101 and a former system status 103 during the sleep mode. The power module 102 is to provide the power of the thin client 1 during the active mode. The network module 104 in the present embodiment is a network interface controller to receive a wake on LAN (WOL) packet 105 to generate a wakeup interrupt 107. The power switch 106 is electrically connected to the processing module 108 when the thin client host is in the sleep mode. After the processing module 108 receives the wakeup interrupt 107 generated by the network module 104, the processing module 108 checks if the storing module 100 stores a sleep flag 101. If the storing module 100 doesn't have the sleep flag 101, the processing module 108 determines that the thin client host 1 is not in a sleep mode and turns on the system according to a normal boot process. If the storing module 100 has the sleep flag 101, the processing module 108 determines that the thin client host 1 is in a sleep mode.

After making sure that the thin client host 1 is in a sleep mode, the processing module 108 further performs a wakeup process 109 and a power management process 111. The wakeup process 109 and the power management process 111 are actually stored in the lowest address of the system memory 110 before the thin client host 1 enters the sleep mode. By storing the processes in the lowest address, the thin client host 1 can shut down the power of higher address part of the system memory 100 in the sleep mode. The processing module 108 transfer a trigger signal 113 to the power module 102 to activate the power module 102 according to the power management process 111 to supply the power of the thin client host 1 when it is back to the active mode. The processing module 108 further switches the power switch 106 from the processing module 108 to the power module 102. Then, the processing module 108 retrieves the former system status 103 from the storing module 100 according to the wakeup process 109 to switch the thin client host 1 from the sleep mode back to the active mode according to the former system status 103.

The power switch 106 is electrically connected to the power module 102 during the active mode and is electrically connected to the processing module 108 during the sleep mode. Thus, during the sleep mode, when the power switch 106 is triggered, the power switch 106 won't directly reset the power module 102 to reboot the system to avoid losing the former system status 103 stored in the storing module 100. When the power switch 106 is triggered during sleep mode, the power switch 106 will send a wakeup interrupt 115 to the processing module 108 instead. The wakeup interrupt 115 and the wakeup interrupt 107 are substantially the same interrupt that will further perform the wakeup process 109 and the power management process 111 to switch the thin client host 1 back to the active mode. The processing module 108 retrieves the former system status 103 of the thin client host 1 according to the wakeup process 109. The former system status 103 comprises the variables of the system and the data in the system memory 110 of the thin client host 1 before the thin client host 1 enters the sleep mode. The wakeup process 109 further restores the operation frequency of the processing module 108 and activates the power of the peripheral devices to restore the active mode.

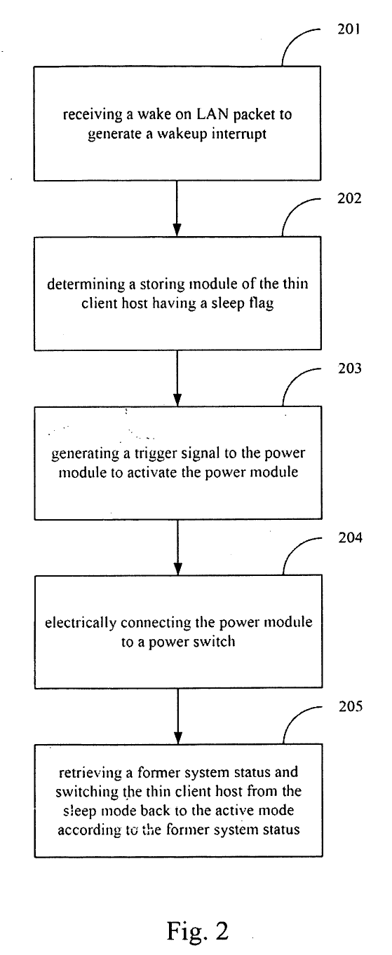

FIG. 2 is a flow chart of the thin client host wakeup method of the second embodiment of the present invention. The thin client host wakeup method switches a thin client host as described in the first embodiment from a sleep mode back to an active mode, wherein the thin client host wakeup method comprises the steps of: in step 201, receiving a wake on LAN packet to generate a wakeup interrupt; in step 202, determining a storing module of the thin client host having a sleep flag; in step 203, generating a trigger signal to the power module to activate the power module; in step 204, electrically connecting the power module to a power switch; and in step 205, retrieving a former system status and switching the thin client host from the sleep mode back to the active mode according to the former system status.

The thin client host and the thin client host wakeup method of the present invention receive the wake on LAN packet through the network module, and make the power switch switch between the power module and the processing module in different modes to simulate the wakeup process. The thin client thus doesn't need a complex power management system such as advanced configuration and power Interface (ACPI) to accomplish the wakeup mechanism.

It will be apparent to those skilled in the art that various modifications and variations can be made to the structure of the present invention without departing from the scope or spirit of the invention. In view of the foregoing, it is intended that the present invention cover modifications and variations of this invention provided they fall within the scope of the following claims.

What is claimed is:

1. A thin client host having a sleep mode and an active mode, wherein the thin client host comprises:
a storing module to store a sleep flag during the sleep mode;
a power module to provide the power of the thin client during the active mode;
a network module to receive a wake on LAN (WOL) packet to generate a wakeup interrupt; and
a processing module to receive the wakeup interrupt to determine the storing module has the sleep flag and further generate a trigger signal to the power module to activate the power module and electrically connect the power module to a power switch, the processing module further retrieves a former system status and switches the thin client host from the sleep mode back to the active mode according to the former system status.

2. The thin client host of claim 1, wherein the network module is a network interface controller (NIC).

3. The thin client host of claim 1, when the thin client host is in the sleep mode, the power switch is electrically connected to the processing module.

4. The thin client host of claim 3, when the thin client host is switched from the sleep mode back to the active mode, the processing module switches the power switch from the processing module to the power module.

5. The thin client host of claim 3, when the power switch is triggered during the sleep mode, the power switch generates the wakeup interrupt to the processing module.

6. The thin client host of claim 1, further comprising a system memory to store a wakeup process and a power management process during the sleep mode, the processing module switches the thin client host from the sleep mode back to the active mode according to the wakeup process and the power management process.

7. The thin client host of claim 6, wherein the wakeup process and the power management process are stored in the lowest address of the system memory.

8. A thin client host wakeup method to switch a thin client host from a sleep mode back to an active mode, wherein the thin client host wakeup method comprises the steps of:
receiving a wake on LAN packet to generate a wakeup interrupt;
determining a storing module of the thin client host having a sleep flag;
generating a trigger signal to the power module to activate the power module;
electrically connecting the power module to a power switch; and
retrieving a former system status and switching the thin client host from the sleep mode back to the active mode according to the former system status.

9. The thin client host wakeup method of claim 8, wherein the wake on LAN packet is received by a network interface controller.

10. The thin client host wakeup method of claim 8, wherein the thin client host comprises a processing module, when the thin client host is in the sleep mode, the power switch is electrically connected to the processing module.

11. The thin client host wakeup method of claim 10, when the thin client host is switched from the sleep mode back to the active mode, the thin client host wakeup method further comprises a step of switching the power switch from the processing module to the power module.

12. The thin client host wakeup method of claim 10, when the power switch is triggered during the sleep mode, the power switch generates the wakeup interrupt.
